(19) United States
(12) Patent Application Publication
(10) Pub. No.: US 2020/0138079 A1
(43) Pub. Date: May 7, 2020

(54) 3D PRINTING TECHNOLOGY-BASED METHOD FOR USE IN ADJUSTING DIGESTIBILITY OF HIGHLAND BARLEY STARCH

(71) Applicant: South China University of Technology, Guangzhou,Guangdong (CN)

(72) Inventors: Ling CHEN, Guangzhou (CN); Bo ZHENG, Guangzhou (CN); Shaowen ZHONG, Guangzhou (CN); Xiaoxi LI, Guangzhou (CN)

(73) Assignee: South China University of Technology, Guangzhou,Guangdong (CN)

(21) Appl. No.: 16/608,991

(22) PCT Filed: Nov. 21, 2017
(86) PCT No.: PCT/CN2017/112099

§ 371 Date: Nov. 7, 2019

(30) Foreign Application Priority Data
Apr. 28, 2017 (CN) 201710295311.9

(51) Int. Cl. A23L 33/00; A23L 29/30

(52) U.S. Cl. CPC A23L 33/00; A23L 29/212; A23L 29/30

(57) ABSTRACT

Disclosed is a 3D printing technology-based method for use in adjusting the digestibility of highland barley starch, comprising the following steps: (1) after mixing highland barley starch with water, adding an edible oil, thoroughly and uniformly mixing, and then forming a starch-oil complex system, the mass ratio of highland barley starch to water and oil being 1:(0.5-2):(0.2-1); (2) adding the uniformly mixed starch-oil complex system into a material cylinder of a 3D printer, setting a transfer temperature to 50° C.-100° C. and maintaining for 10-30 min, then performing 3D printing at a printing temperature of 150° C.-210° C. to obtain a highland barley starchy food product having a 3D stereoscopic shape. By means of 3D additive manufacturing technology combined with thermal treatment, the slow digestion and indigestibility of highland barley starch may be intelligently improved, and the nutritional value of highland barley starch food products may be enhanced, meeting the requirements of specific populations.

### TECHNICAL FIELD

The present invention belongs to the fields of starch modification and nutrition regulation, and specifically relates to a 3D printing technology-based method for use in adjusting the slow digestion and indigestibility of highland barley starch.

### BACKGROUND ART

Starch is the main source of energy for human beings. Its digestibility has a great impact on human health and is closely related to metabolic diseases such as diabetes, hyperlipidemia and obesity. Starch can be divided into rapidly digestible starch, slowly digestible starch and resistant starch according to different digestibilities. The slowly digestible starch has a slow digestion rate in the human body and can slowly release glucose in the human body, which is beneficial to the stability of blood sugar in the human body. The resistant starch is a new type functional material that has been extensively studied in recent years. Although it can not be digested and absorbed by the small intestine to provide energy to the body, it can be fermented as a dietary fiber by the intestinal microbial flora to produce short-chain fatty acids, improve the environment of the intestinal flora, and reduce the incidence of diseases such as rectal cancer. The latest research shows that the resistant starch is also directly related to human obesity, diabetes and regulating human immune function and improving human health.

Currently, the resistant starch is classified into five types: physically unavailable starch (RS1), native starch granules with structures making them slow to digest (RS2), retrograded starches (RS3), modified starches (RS4), and starch-lipid complex (RS5). Since the content of the naturally occurring RS1 or RS2 is less and the content of the resistant starch in the raw starches is very low (generally less than 10%), with the high amylose corn starch having the highest content (about 10%), it is difficult to meet the application needs only by extracting and separating RS1 and RS2 resistant starch from natural starch. Currently, the main ways to increase the content of the resistant starch in starch include: RS3 formed by the re-association of starch due to the role of hydrogen bonds in the molecule during the retrogradation; and RS4 formed by structural changes caused by physical or chemical modification of starch; and starch and lipid complex RS5. Situ W. et al. used the retrograded starch to prepare and obtain the RS3 resistant starch, increasing the content of the resistant starch by 2-5 times, which is of great significance for regulating human health (Journal of agricultural and food chemistry, 2014, 62 (16): 3599-3609); Miao M. et al. used pullulanase to debranch starch and to recrystallize it at low temperature, increasing the content of the resistant starch by up to 4-5 times (Carbohydrate polymers, 2009, 76 (2): 214-221); Han J A et al. grafted octenyl succinic acid (OSA) on starch molecules, making the content of the indigestible starch reach 13.9%-32.8% (Carbohydrate polymers, 2007, 67 (3): 366-374); Wang H. et al. carried out the damp-thermal treatment of rice starch, increasing the content of the resistant starch by 2-4 times and making it reach 29.6% (International journal of biological macromolecules, 2016, 88: 1-8); RS5 “starch-lipid complexes” are complexes with an resistance to enzymatic degradation formed by the complexation of amylose with lipids, which are a class of the resistant starch developed in recent years. There are two structures of single helix and double helix in starch granules. Under certain conditions, the internal hydrophobic end of the cavity formed by the starch chain interacts with the lipid ligand to form a stable starch-lipid complex. Chang F. et al. used lauric acid and corn starch granules to form the RS5 resistant starch structure under high-speed shearing conditions in aqueous phase, reducing the digestibility of the corn starch. Through research, Ahmadi-Abhari et al. found that the addition of a certain amount of lysolecithin to the slow digestible starch (after thermal treatment and cooling for 240 min) produces a starch-lipid complex that is insensitive to amylase. Currently, the fifth type of the resistant starch “starch-lipid complex” is gradually favored due to the easy complexation of starch and lipid (the main components of food) in the food processing process. However, currently, the resistant starch is mainly prepared by using high amylose starches as raw materials and using repeated retrogradation and heat-moisture processing, which results in the problems of complicated process, high cost and low yield; whilst the native starch is complexed with lipids by ways of enzymatic debranching, extrusion and high pressure homogenization to form RS5, which results in the problems of low complexation rate and special equipment requirements.

As the exclusive species in the Qinghai-Tibet Plateau and the most plateau-specific crop, highland barley has characteristics of unique components and high nutritional values, which has received great attention in the field of nutritional health foods in recent years. Highland barley contains polysaccharides such as β-glucan and arabinoxylan, phenolic substances and phytosterols, all of which have a nutritional function that regulates postprandial blood sugar levels. Starch, which is the main component of highland barley, accounts for about 75%-80% of the whole endosperm, but it is easily digested and degraded by amylase. Therefore, the function of highland barley powder regulating the blood sugar will be affected, which has great obstacles to the development of functional and nutritional foods of starch.

### SUMMARY OF THE INVENTION

In order to solve the problems in the prior art, the present invention provides a 3D printing technology-based method for use in enhancing the slow digestibility and indigestibility of highland barley starch. Improving the nutritional function characteristics of highland barley starch food products can meet the needs of different consumers.

The objective of the present invention is implemented using the following technical solutions:

a 3D printing technology-based method for use in adjusting the digestibility of highland barley starch, comprising the following steps:

(1) after mixing highland barley starch with water, adding an edible oil, thoroughly and uniformly mixing, and then forming a starch-oil complex system, the mass ratio of highland barley starch to water and oil being 1:(0.5-2):(0.2-1);

(2) adding the uniformly mixed starch-oil complex system into a material cylinder of a 3D printer, setting a transfer temperature to 50° C.-100° C. and maintaining for 10-30 min, then performing 3D printing at a printing temperature of 150° C.-210° C. to obtain a highland barley starchy food product having a 3D stereoscopic shape.

The mass ratio of highland barley starch to water and oil is 1:(1-2):(0.5-1).

The transfer temperature is 75° C.-80° C.

The printing temperature is 170° C.-210° C.

The printing temperature is 170° C.-210° C.

The oil is palm oil, soybean oil or peanut oil.

The present invention utilizes 3D additive processing technology and thermal treatment to achieve the transformation and breakthrough of the traditional thermal processed food processing technology and means; regulates the interaction among starch molecules and between starch molecules and lipid molecules in a food system by controlling conditions of thermal treatment and 3D printing molding; induces and strengthens the interaction and coupling among starch molecules and between starch molecules and lipid molecules; constructs highland barley starchy food products with different digestibilities, meeting the nutritional function requirements of the human body.

Compared with the prior art, the present invention has the following advantages:

(1) by controlling the proportion of highland barley starch, water and oil in raw materials and the system transfer temperature and printing temperature in the 3D printer, and by changing the multi-layer structure of starch and controlling the complexation of starch and lipid, the present invention can achieve the characteristic of adjusting the slow digestibility and indigestibility of starch, which significantly improves the content of the slow digestible starch and the resistant starch in the three-dimensional highland barley starchy food products after printing, and imparts the functional and nutritional characteristic of regulating blood sugar level to highland barley starchy food products.

(2) by regulating the proportion of highland barley starch, water and oil in raw materials, the present invention adjusts its rheological behavior and imparts its molding ability, making the obtained highland barley starchy food products (three-dimensional foods) have a good stereoscopic shape and realizing personalized food customization.

### DETAILED DESCRIPTION OF EMBODIMENTS

The present invention will be further described in detail in conjunction with embodiments below, but the implementations of the present invention are not merely limited thereto.

### Embodiment 1

Highland barley starch and soybean oil are selected as raw materials. According to the proportion of highland barley starch: water: oil of 1:0.5:0.2, water is firstly added to the highland barley starch for preliminary mixing, and then oil is added for thoroughly mixing with a stirrer. Then, the uniformly mixed starch-oil complex system is added into a material cylinder of a 3D printer. After setting the transfer temperature and maintaining for 30 min, 3D printing is performed at the printing temperature.

In vitro digestibility determination is performed on the highland barley starch and oil complex obtained by 3D printing, wherein the content of rapidly digestible, slowly digestible and indigestible components are shown in Table 1.

TABLE 1

| | | | | | | Slow |
|---|---|---|---|---|---|---|
| | | | | | | digestible |
| Highland | Soy- | | | Printing | | starch |
| barley | bean | | Transfer | temp- | Fast | (%) + |
| starch | oil | Water | temperature | erature | digestible | resistant |
| (g) | (g) | (g) | (° C.) | (° C.) | starch (%) | starch (%) |
| 30 | 6 | 15 | 50 | 150 | 79.04% | 20.96% |

### Embodiment 2

Highland barley starch and soybean oil are selected as raw materials. According to the proportion of highland barley starch: water: oil of 1:1:0.2, water is firstly added to the highland barley starch for preliminary mixing, and then oil is added for thoroughly mixing with a stirrer. Then, the uniformly mixed starch-oil complex system is added into a material cylinder of a 3D printer. After setting the transfer temperature and maintaining for 25 min, 3D printing is performed at the printing temperature.

In vitro digestibility determination is performed on the highland barley starch and oil complex obtained by 3D printing, wherein the content of rapidly digestible, slowly digestible and indigestible components are shown in Table 2.

TABLE 2

| | | | | | | Slow |
|---|---|---|---|---|---|---|
| | | | | | | digestible |
| Highland | Soy- | | | Printing | | starch |
| barley | bean | | Transfer | temp- | Fast | (%) + |
| starch | oil | Water | temperature | erature | digestible | resistant |
| (g) | (g) | (g) | (° C.) | (° C.) | starch (%) | starch (%) |
| 30 | 6 | 30 | 65 | 170 | 74.91% | 25.09% |

### Embodiment 3

Highland barley starch and soybean oil are selected as raw materials. According to the proportion of highland barley starch: water: oil of 1:1.5:0.2, water is firstly added to the highland barley starch for preliminary mixing, and then oil is added for thoroughly mixing with a stirrer. Then, the uniformly mixed starch-oil complex system is added into a material cylinder of a 3D printer. After setting the transfer temperature and maintaining for 10 min, 3D printing is performed at the printing temperature.

In vitro digestibility determination is performed on the highland barley starch and oil complex obtained by 3D printing, wherein the content of rapidly digestible, slowly digestible and indigestible components are shown in Table 3.

TABLE 3

| | | | | | | Slow |
|---|---|---|---|---|---|---|
| | | | | | | digestible |
| Highland | Soy- | | | Printing | | starch |
| barley | bean | | Transfer | temp- | Fast | (%) + |
| starch | oil | Water | temperature | erature | digestible | resistant |
| (g) | (g) | (g) | (° C.) | (° C.) | starch (%) | starch (%) |
| 30 | 6 | 45 | 80 | 170 | 67.18% | 32.82% |

### Embodiment 4

Highland barley starch and soybean oil are selected as raw materials. According to the proportion of highland barley starch: water: oil of 1:1.5:0.5, water is firstly added to the highland barley starch for preliminary mixing, and then oil is added for thoroughly mixing with a stirrer. Then, the uniformly mixed starch-oil complex system is added into a material cylinder of a 3D printer. After setting the transfer temperature and maintaining for 15 min, 3D printing is performed at the printing temperature.

In vitro digestibility determination is performed on the highland barley starch and oil complex obtained by 3D printing, wherein the content of rapidly digestible, slowly digestible and indigestible components are shown in Table 4.

TABLE 4

| | | | | | | Slow |
|---|---|---|---|---|---|---|
| | | | | | | digestible |
| Highland | Soy- | | | Printing | | starch |
| barley | bean | | Transfer | temp- | Fast | (%) + |
| starch | oil | Water | temperature | erature | digestible | resistant |
| (g) | (g) | (g) | (° C.) | (° C.) | starch (%) | starch (%) |
| 30 | 15 | 45 | 75 | 180 | 67.73% | 32.27% |

### Embodiment 5

Highland barley starch and soybean oil are selected as raw materials. According to the proportion of highland barley starch: water: oil of 1:2:1, water is firstly added to the highland barley starch for preliminary mixing, and then oil is added for thoroughly mixing with a stirrer. Then, the uniformly mixed starch-oil complex system is added into a material cylinder of a 3D printer. After setting the transfer temperature and maintaining for 10 min, 3D printing is performed at the printing temperature.

In vitro digestibility determination is performed on the highland barley starch and oil complex obtained by 3D printing, wherein the content of rapidly digestible, slowly digestible and indigestible components are shown in Table 5.

TABLE 5

| | | | | | | Slow |
|---|---|---|---|---|---|---|
| | | | | | | digestible |
| Highland | Soy- | | | Printing | | starch |
| barley | bean | | Transfer | temp- | Fast | (%) + |
| starch | oil | Water | temperature | erature | digestible | resistant |
| (g) | (g) | (g) | (° C.) | (° C.) | starch (%) | starch (%) |
| 30 | 30 | 60 | 75 | 210 | 64.56% | 35.44% |

1. A 3D printing technology-based method for use in adjusting the digestibility of highland barley starch, characterized by comprising the following steps:
(1) after mixing highland barley starch with water, adding an edible oil, thoroughly and uniformly mixing, and then forming a starch-oil complex system, the mass ratio of highland barley starch to water and oil being 1:(0.5-2):(0.2-1);
(2) adding the uniformly mixed starch-oil complex system into a material cylinder of a 3D printer, setting a transfer temperature to 50° C.-100° C. and maintaining for 10-30 min, then performing 3D printing at a printing temperature of 150° C.-210° C. to obtain a highland barley starchy food product having a 3D stereoscopic shape.

2. The method according to claim 1, characterized in that the mass ratio of highland barley starch to water and oil is 1:(1-2):(0.5-1).

3. The method according to claim 1 or 2, characterized in that the transfer temperature is 75° C.-80° C.

4. The method according to claim 1 or 2, characterized in that the printing temperature is 170° C.-210° C.

5. The method according to claim 3, characterized in that the printing temperature is 170° C.-210° C.

6. The method according to claim 3, characterized in that the oil is palm oil, soybean oil or peanut oil.

7. A highland barley starch food product having a 3D stereoscopic shape obtained by the method according to any one of claims 1-6.
